(19) United States
(12) Patent Application Publication
(10) Pub. No.: US 2019/0034474 A1
(43) Pub. Date: Jan. 31, 2019

(54) Resolving Inconsistencies in Information Graphs

(71) Applicant: The Fin Exploration Company, San Francisco, CA (US)

(72) Inventors: Venkataramanan Iyer Nandagopal, San Francisco, CA (US); Greg Einfrank, San Francisco, CA (US); Samuel Lessin, San Francisco, CA (US); Andrew Kortina, San Francisco, CA (US); Robert Cobb, San Francisco, CA (US); Jeremiah Rogers, San Francisco, CA (US); David Seeto, San Francisco, CA (US); Ben Vishny, Winetka, IL (US); Daniel Cosson, San Francisco, CA (US)

(73) Assignee: The Fin Exploration Company, San Francisco, CA (US)

(21) Appl. No.: 16/043,078

(22) Filed: Jul. 23, 2018

Related U.S. Application Data
(63) Continuation of application No. 15/473,449, filed on Mar. 29, 2017.

(51) Int. Cl. G06F 17/30

(52) U.S. Cl. CPC G06F 17/30371; G06F 17/30598; G06F 17/30958

(57) ABSTRACT

Methods, systems, and apparatus, including computer programs encoded on computer storage media, for resolving inconsistencies in information graphs. One of the systems includes one or more computers configured to perform operations comprising: maintaining data representing an information graph that includes claims about entities, wherein the maintained data comprises data representing a plurality of clusters, each cluster corresponding to a different entity and comprising a plurality of claims about the corresponding entity, and wherein the maintained data comprises, for each claim in each cluster, a respective data structure that identifies at least (i) the corresponding entity for the cluster, (ii) an attribute value of the corresponding entity about which the claim is an assertion, and (iii) a respective claimant user that made the assertion in the claim, receiving a request for a value of a particular attribute of a particular entity that has been submitted by a requesting user; determining, from the maintained data, that the claims in a particular cluster corresponding to the particular entity assert at least two different values for the particular attribute; determining, from attribute values for the particular attribute identified by the claims in the particular cluster, a user-specific attribute value for the particular attribute value; and providing the user-specific attribute value in response to the request.

### BACKGROUND

This specification generally relates to maintaining an information graph that stores information about entities.

Existing systems store information about values of attributes of entities in various ways. These existing systems, however, are generally only able to respond to a user request by returning a value that has been determined to be the globally correct value of a given attribute without considering the perspective of the user submitting the request.

### SUMMARY

In general, one innovative aspect of the subject matter described in this specification can be embodied in methods that include the actions of maintaining data representing a particular cluster of a plurality of claims about a particular entity, wherein each claim is an assertion by a respective claimant about an attribute value of the particular entity; receiving a request for a value of a particular attribute of the particular entity that has been submitted by a requesting user; determining, from attribute values for the particular attribute identified by the claims in the particular cluster, a user-specific attribute value for the particular attribute value; and providing the user-specific attribute value in response to the request.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages.

Systems that maintain data about entities, e.g., data identifying attribute values for various attributes of the entities, can receive large numbers of user-submitted and automatically-generated requests to add new information to the maintained data. Many of these requests can be inconsistent with one another, e.g., two different requests about the same entity can assert that two different values are the correct value for the same attribute of the entity.

To avoid storing an excessive amount of data and processing delays, existing systems determine which received value is the globally correct value for a given attribute and always return the same globally correct value as the correct value in response to user requests. However, this results in an information loss. In particular, this manner of processing received entity data prevents the existing systems from returning different attribute values for the same attribute when both attribute values may be correct in different contexts.

The described system, however, maintains data about entities as possibly inconsistent claims. That is, for a given entity, different claims about the entity may be inconsistent with one another. For example, one claim may indicate that value A is the correct value for a given attribute while another indicates that value B is the correct value for the attribute.

By maintaining data about entity attribute values as claims as described in this specification, attribute values can be returned in response to received queries in a manner that better satisfies users' informational needs while minimizing the amount of additional computational resources, e.g., memory and processing power, consumed by the system in storing possibly inconsistent data.

In particular, claims can be resolved in a computationally-efficient manner to determine the value of the attribute that is personalized for the requesting user, resulting in the returned attribute values better satisfying the requesting user's informational needs.

For example, determining the value of the attribute to be returned in response to the user request can take into account not only a level of confidence in a user submitting a given claim about the attribute value, but also the relationship between the requesting user and the submitting user.

Additionally, attribute values that are returned can take into consideration a given claimant retracting or changing their opinion about the true value of the attribute, since the attribute values can effectively be re-computed periodically or even each time a user request is received.

Additionally, by maintaining data about entity attribute values as claims, attribute values for which there is agreement between claimants or attribute values that are controversial can easily be identified.

By tracking when claims were made, the attribute value can evolve over time, giving greater weight to more recent claims over older claims, to claims that remain uncontested for longer, or both.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example information graph system.

FIG. 2 is a flowchart of an example process for determining the value of an attribute in response to a received request.

FIG. 3 is a flowchart of an example process for identifying a responsive cluster for a received request.

FIG. 4 is a flowchart of an example process for determining a user-specific attribute value from claims in a responsive cluster.

Like reference numbers and designations in the various drawings indicate like elements.

### DETAILED DESCRIPTION

This specification generally describes a system that maintains an information graph that includes claims about entities in the system.

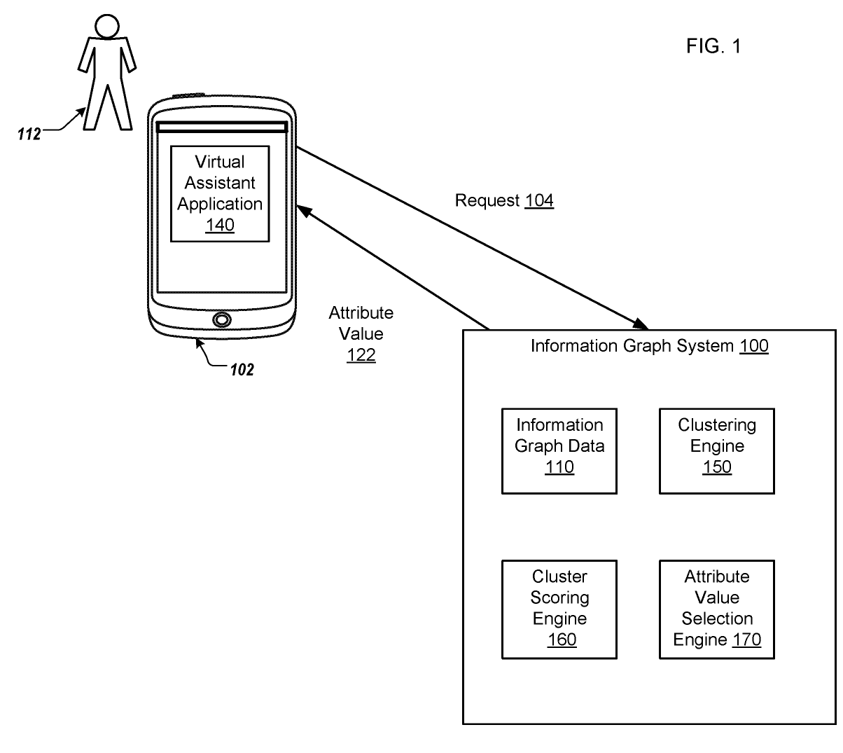

FIG. 1 shows an example information graph system 100. The information graph system 100 is an example of a system implemented as computer programs on one or more computers in one or more locations, in which the systems, components, and techniques described below can be implemented.

The information graph system 100 maintains data 110 representing an information graph.

The information graph 110 is a collection of claims about entities. Generally, an entity is a topic, e.g., a person, place, thing, or concept. Examples of entities may include people, businesses, geographic locations, works of art, fictional characters, animals, and so on.

A claim about an entity is a series of assertions about an attribute of that entity. Such assertions can include the identity of the source of the claim, the value of the attribute, and the source's sentiment concerning that value. An example of a claim is “Venky Iyer asserts that 12345 Main Street is the true address of The Fin Exploration Company.” In that example, “Venky Iyer” would be the source of the claim, “12345 Main Street” is the value of the attribute, and “true” is the source's sentiment concerning that value.

The source, which will also be referred to in this specification as a claimant, does not need to be a person. The information graph system 100 may, for example, generate a claim using an algorithm, or collect the claim from another data source or system.

The source's sentiment concerning a value can be true (i.e., correct), false (i.e., incorrect) or some other sentiment, such as obsolete, irrelevant, or no longer current. Sentiment may also include the source's confidence level. For example the source may be highly confident the assertion is true, or only somewhat confident the assertion is false.

In some cases, a claimant may directly submit a claim to the information graph system 100 that reflects an attribute value and the claimant's sentiment about that attribute value.

For example, the information graph system 100 may provide a user interface for presentation on a user device of a claimant that allows the claimant to submit claims about attributes of a particular entity.

This interface may enable the claimant to fill in missing values of attributes concerning an entity, (i.e., to assert a value of an attribute that was previously unknown) and express a sentiment concerning a value. In some cases where the claimant is submitting a missing value, the information graph system 100 will automatically infer that the claimant's sentiment concerning the value is true or correct, and that the user's confidence level is high. In some cases, the interface may allow the user to submit a sentiment other than true or false, and may also allow the user to express a confidence level in the submitted sentiment.

In the case of values that have already been filled in, the interface may enable a claimant to assert that a previously claimed value (either by the claimant or another source) is an incorrect value, and may also enable the claimant to express a confidence level in that assertion. As an example, the user interface may allow the claimant to add an address for a restaurant or to indicate that she is highly confident that the currently displayed address for the restaurant is incorrect.

In some cases, the information graph system 100 may generate claims based on other interactions of a claimant with the system or with another data source or system that are indicative of an assertion about an attribute.

In particular, in some implementations, the information graph system 100 is in communication with, or is implemented as part of, an application used by a claimant, e.g., a virtual assistant application 140 installed on a mobile device 102. The virtual assistant application 140 is a software application that carries out tasks on behalf of a user 112. Examples of tasks may include scheduling a meeting for the user, making travel plans for the user, setting reminders for the user, making restaurant reservations, shopping for the user, and many others. The virtual assistant application 140 may also include a messaging functionality to allow the user to send messages to other users.

In these implementations, the information graph system 100 may generate claims based on actions taken by the user of the mobile device 102 with respect to the virtual assistant application 140 or to another application used by the user.

For example, the information graph system 100 may generate a claim based on a user sending an email intended for a particular person to a particular email address. In that case, the user would be the source of the claim, and the claim would be an assertion that the particular email address is the true email address for the particular person. As another example, the information graph system 100 may generate a claim based on the user receiving a response to the email to the particular email address indicating that the email was undeliverable. In this case, the source would be the email provider, and the claim would be an assertion that the particular email address is an incorrect email address for that particular person.

As another example, the information graph system 100 may generate a claim based on a user adding a particular restaurant to a “favorite restaurants” list. In this case, the user would be the source, and the claim would be an assertion that the value of the quality attribute for that restaurant is “good.”

The system can represent the claims in the information graph using any of a variety of appropriate data structures.

For example, each claim can be stored as a tuple that identifies an entity, an attribute concerning the entity, a value for the identified attribute, an asserted sentiment with respect to the identified value, the source of the claim, i.e., an identifier for the claimant of the information that resulted in the claim being generated, and, optionally, other metadata characterizing the claim, e.g., a confidence level of the source in the assertion made in the claim, the time that the claim was submitted, the location of the claimant relative to the entity, and so on.

The information graph system 100 generates and maintains clusters of claims, with each cluster corresponding to a respective entity. That is, the claims in a given cluster are each assertions about attributes concerning the same entity, i.e., the entity that corresponds to the cluster. Generally, claims in the same cluster may refer to the same entity in different ways, i.e., different claims may use different names or different titles to refer to the same entity. The information graph system 100 clusters the claims so that each claim corresponding to the same entity is in the same cluster even if the claims identify the entity differently.

In particular, the information graph system 100 includes a clustering engine 150 that clusters the claims such that the claims in a given cluster are each assertions about attributes of an entity corresponding to the given cluster.

In some implementations, the clustering engine 150 applies multiple different clustering strategies to the claims represented by the information graph data 110 to generate a set of candidate clusters for each clustering strategy. The clustering engine 150 can then determine a measure of coherency of each of the candidate clusters and maintain the most-coherent candidate clusters as the final set of clusters. The multiple different clustering strategies can include clustering on different attributes that are likely to be unique to a particular entity, e.g., addresses for entities that have permanent geographic locations, phone numbers, or email addresses, clustering on the same attributes using different clustering algorithms, or both.

In some implementations, the clustering engine 150 can cluster the claims in a manner that incorporates user feedback. For example, once the most coherent candidate clusters have been selected, the clustering engine 150 may provide some or all of the clusters of claims for editing by one or more users and allow the users to submit inputs removing or adding claims from the presented clusters.

In many cases, different claims concerning a particular attribute within a cluster may contradict each other, i.e., some claims within a given cluster may assert that a particular value for an attribute is true, while other claims may assert that the same value is false and yet other claims assert that a different value is the true value of the attribute.

Because different claimants will have different perspectives on what should be the true value of a particular attribute, various claims in a cluster can convey different sentiments about the same attribute value. For example, if a restaurant has moved, some claims may say that the old address is correct, while others may say the new address is correct. As another example, a particular person may have several different email addresses, e.g., one email address for work and one personal email address. Claimants who interact with the particular person primarily for business may indicate that the work email address is the correct or preferred email address for the particular person, while claimants who interact with the particular personal primarily outside of work may indicate that the personal email address is the correct or preferred email address.

When the information graph system 100 receives a request for the value of a particular attribute for a particular entity from a requesting user, and the information graph contains multiple claims containing different values for that attribute, the system can respond with the value that is most likely to be true based on the number of claims made relating to each value and, in some cases, the sentiment and corresponding confidence level of the claimants. In this case, all users would receive the same “canonical” response from the system concerning that value.

In other implementations, the information graph system 100 can return different values of the particular attribute depending on which user requested the value and what information the system has access to about that user.

For example, assume the information graph system 100 has a work email address and a personal email address for Jane Smith. If a user requests Jane Smith's email address, and the information graph system 100 has access to information that indicates that the user and Jane Smith both have children who attend the same school, or both have calendar invites for events at the same school, or even both live within walking distance from the same school, the information graph system 100 might return Jane Smith's personal email. But if the information graph system 100 has access to information that indicates that the user sells dental supplies, and Jane Smith is a dentist, the information graph system 100 might return Jane's Smith's work email address.

For example, the information graph system 100 can receive a request 104 through a wired or wireless data communication network, e.g., local area network (LAN) or wide area network (WAN), e.g., the Internet, or a combination of networks, from the user 112 of the mobile device 102 for the value of a particular attribute for a particular entity.

In response to the request 104, the information graph system 100 can identify a cluster of claims that include values for an attribute of a particular entity, and use the claims in the identified cluster to determine a user-specific value 122 for the particular attribute. The information graph system 100 can then provide data identifying the user-specific attribute value 122 to the mobile device 120 in response to the request 104.

In particular, the information graph system 100 includes a cluster scoring engine 160 and an attribute value selection engine 170.

In response to the request 104, the cluster scoring engine 160 scores the maintained clusters and selects a maintained cluster as the responsive cluster for the request 104.

The attribute value selection engine 170 then determines, from values for the particular attribute that are identified in claims in the responsive cluster, a set of candidate values for the particular attribute and selects the user-specific attribute value 122 from the candidate values. The attribute value selection engine 170 selects the user-specific attribute value 122 based on features that take into consideration the relationship of the claimants for the claims in the responsive cluster to the requesting user.

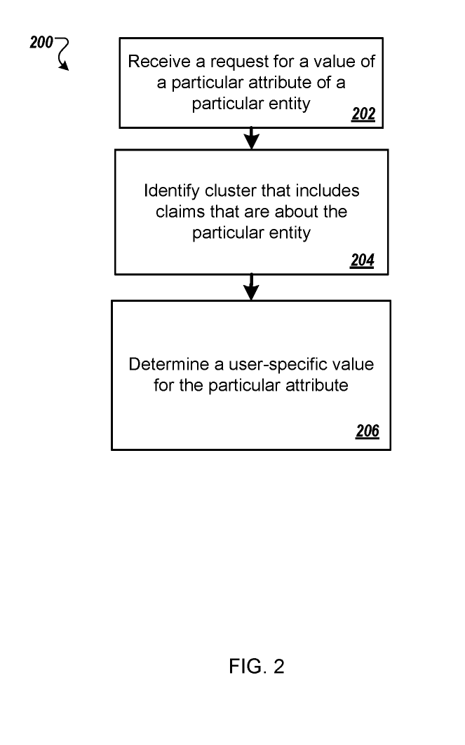

Processing a request to determine a user-specific value of a particular attribute is described in more detail below with reference to FIGS. 2-4.

FIG. 2 is a flowchart of an example process 200 for determining the value of an attribute in response to a received request. For convenience, the process 200 will be described as being performed by a system of one or more computers, located in one or more locations, and programmed appropriately in accordance with this specification. For example, an information graph system, e.g., the information graph system 100 of FIG. 1, appropriately programmed, can perform the process 200.

The system receives a request for the value of a particular attribute of a particular entity that has been submitted by a requesting user (step 202).

In some cases, the request may have been explicitly submitted by the requesting user. For example, the requesting user can submit a query to the system through a user device of the requesting user.

In some other cases, the request may have been generated by the system or by a different system as part of carrying out a task on the user's behalf.

For example, the user may have requested that a virtual assistant application make a restaurant reservation at a restaurant near the current location of the user. The virtual assistant application or another system in communication with the virtual assistant application may then generate a request to the system for the value of a “quality” attribute (such as a rating) for each restaurant that is located within a threshold distance of the user's current location as part of identifying the restaurant at which to make the requested reservation.

As another example, the user may have requested that the virtual assistant application send an email to a particular person. The virtual assistant application or another system in communication with the virtual assistant application may then generate a request to the system for the value of a “preferred email address” attribute for the particular person.

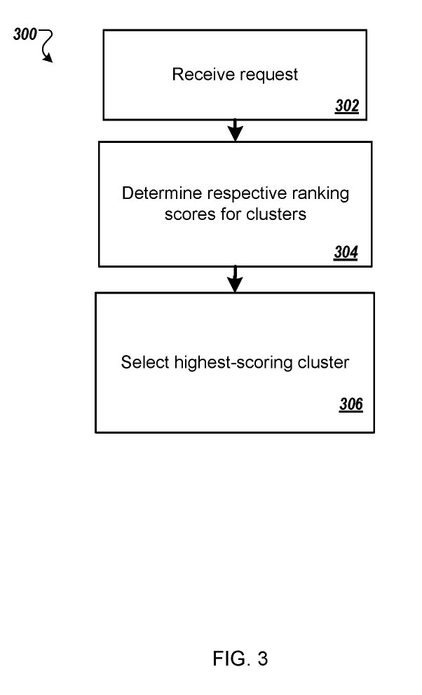

The system identifies the cluster that includes claims that are about the particular entity (step 204). In particular, the system determines the cluster that is most responsive to the received request. Determining a responsive cluster for a received request is described in more detail below with reference to FIG. 3.

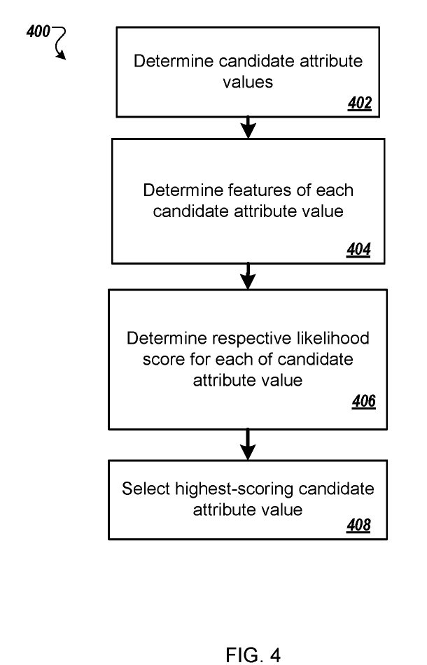

The system determines, from the claims in the responsive cluster that include an assertion about the value of a particular attribute, a user-specific value for the particular attribute (step 206). That is, the system selects a value from the values identified in the claims by resolving the asserted sentiment in the claims in a manner that is specific to the user that submitted the request based on what information the system has access to about that user. Determining a user-specific value from claims in the responsive cluster is described in more detail below with reference to FIG. 4.

The system then provides data identifying the user-specific value in response to the request, i.e., to the requesting user if the request was submitted directly by the user or to the requesting system if the request was submitted as part of carrying out a task on the behalf of the requesting user.

FIG. 3 is a flowchart of an example process 300 for identifying a responsive cluster for a received request. For convenience, the process 300 will be described as being performed by a system of one or more computers, located in one or more locations, and programmed appropriately in accordance with this specification. For example, an information graph system, e.g., the information graph system 100 of FIG. 1, appropriately programmed, can perform the process 300.

The system receives a request for the value of a particular attribute of a particular entity that has been submitted by a requesting user (step 302).

The system determines a respective ranking score for each of multiple clusters (step 304). In some implementations, the system scores each cluster in the information graph. In other implementations, the system scores only a subset of the clusters in the information graph, e.g., because the system obtains data identifying certain clusters as not relevant to the received query or to searches submitted by the requesting user.

In particular, for each of the multiple clusters, the system generates a respective characteristic score for each of multiple characteristics and then combines the characteristic scores to generate the ranking score for the cluster. For example, the system can combine the characteristic scores by computing a weighted sum of the characteristic scores, a sum of the characteristic scores, a product of the characteristic scores, or an average of the characteristic scores.

The system can consider any of a variety of characteristics in determining the ranking scores for the clusters. Generally, however, the characteristics include one or more requester-independent characteristics and, optionally, one or more requester-dependent characteristics.

A requester-independent characteristic is a characteristic for which the characteristic score is the same regardless of which user submitted the request. For example, the characteristic scores can include a request relevance score that measures how relevant the cluster is to the request. As another example, the characteristic scores can include a freshness score that measures how recent the information in the cluster is. As another example, the characteristic scores can include a popularity score that measures the global popularity of the cluster.

A requester-dependent characteristic is a characteristic for which the characteristic score is different for different requesting users.

For example, the characteristic scores can include a requester relevance score that measures how relevant the cluster is to the requesting user. For example, when the cluster represents a person, the requester relevance score can be based at least in part on how many connections, e.g., mutual contacts, the requesting user and the person to whom the claims in the cluster relate have. As another example, the requester relevance score can include a location score that measures how close the location of the entity is to the current location of the requesting user or to a different location associated with the requested user, i.e., the requesting user's residence location.

As another example, the characteristic scores can include a similar user score that measures how relevant the cluster is to users who are similar to the requesting user or who have relationships with the requesting user. For example, a user may be considered to be similar to another user when the two users have more than a threshold number of mutual connections, e.g., contacts.

The system selects the highest-scoring cluster according to the ranking scores as the responsive cluster for the request (step 306).

FIG. 4 is a flowchart of an example process 400 for determining a user-specific attribute value from claims in a responsive cluster. For convenience, the process 400 will be described as being performed by a system of one or more computers, located in one or more locations, and programmed appropriately in accordance with this specification. For example, an information graph system, e.g., the information graph system 100 of FIG. 1, appropriately programmed, can perform the process 400.

The system determines a set of candidate values from the values for the particular attribute that are identified in the claims in the responsive cluster (step 402).

In some implementations, the system includes all values for the particular attribute that have been asserted by at least one claim in the responsive cluster in the set of candidate values.

In some other implementations, the system includes in the set only includes values that have been asserted by at least a threshold number of claims in the responsive cluster, by at least a threshold proportion of claims in the responsive cluster, or by at least a threshold proportion of claims in the responsive cluster that assert a value for the particular attribute.

The system determines features for each of the candidate values (step 404). The features for each of the candidate values include features of the claims in the responsive cluster that make an assertion about the candidate value. In particular, the features for a given claim include a confidence feature, an entity relationship feature, and a requester relationship feature.

The confidence feature for a given claim that makes an assertion about a given candidate value measures a confidence of the claimant submitting the claim that the candidate value is the correct or accurate value for the attribute. The system can determine an initial confidence feature based on the sentiment asserted by the claim. That is, the system can map different sentiments to different initial confidence feature values, with sentiments that indicate that the value is correct being mapped to higher values than sentiments that indicate that the value is not correct, e.g., sentiments that indicate that the value is out of date or inaccurate. If the claim includes a score that indicates how confident the claimant is about the sentiment, the system adjusts the initial confidence feature based on the confidence score.

In some implementations, the system further adjusts the initial confidence feature to normalize the confidence score based on other confidence scores for other claims submitted by the claimant, e.g., by dividing the confidence score in the claim by the average confidence score across all claims submitted by the claimant.

In some implementations, the system also adjusts the initial confidence score based on a reputation score for the claimant that measures how often the value asserted by the claimant as the correct value for an attribute agrees with the majority value, i.e., the canonical value, for a given attribute. In some of these implementations, the system uses a global reputation score for the claimant across all claims submitted by the claimant. In others of these implementations, the system maintains multiple reputation scores, with each score corresponding to a different type of entity, and uses the reputation score for the entity type of the current entity in adjusting the initial confidence feature.

In some implementations, the system also adjusts the confidence feature based on the time the claim was submitted, with more recent claims being favored over older claims.

The entity relationship feature for a given claim measures how related the submitting claimant is to the entity.

In particular, the system determines an initial entity relationship measure that measures how related the claimant is to the particular entity and, optionally, entities that relate to the particular entity. For example, the system can determine the initial entity relationship measure based on the number of claims the claimant has submitted about the entity and, optionally, entities that have been classified as being related to the entity as compared to the total number of claims submitted by the claimant. The system can adjust the initial entity relationship measure based on other signals that indicate relatedness between a claimant and entity, e.g., the number of attribute values that are shared between the claimant and the entity. For example, when the entity is a place, the system can adjust the initial measure based on whether the city of residence of the claimant is within a threshold distance of the location of the entity. As another example, when the entity is a person, the system can adjust the initial measure based on how many contacts are shared between the entity and the claimant, whether certain attributes overlap, e.g., employer, and so on.

The requester relationship feature for a given claim measures how related the submitting claimant is to the requesting user.

In particular, the system determines an initial requester relationship measure that measures how related the claimant is to the requesting user. In some implementations, the initial requester relationship measure is based on which attribute values are shared by the claimant and the requesting user and on how many contacts are shared between the claimant and the requesting user, with claimants that share more attribute values and more contacts with the requesting user being assigned higher initial measures. In some implementations, the system considers only certain attribute values or assigns a greater importance to sharing certain attribute values, e.g., employer, than to sharing other attribute values, e.g., birthplace. In some implementations, the initial requester relationship measure is based on how many times the requesting user and the claimant have submitted claims about the same entity that agree with one another, i.e., that assert the same or similar sentiment about a given attribute value, with claimants that have submitted claims about the same entity as the requesting user more frequently having higher initial measures than other claimants. In some implementations, the system also adjusts the initial requester relationship measure based on how related the claimant is to the requesting user specifically with respect to entities that relate to the particular entity. That is, the system can determine how frequently the claimant has asserted a sentiment about an attribute value that agrees with the sentiment asserted by the requesting user for entities that have been classified as relating to the current entity, i.e., entities of the same type as the current entity.

The system aggregates the features for each of the candidate values to determine a respective likelihood score for each of the candidate values (step 406).

The likelihood score for a given candidate value represents a likelihood that the candidate value is the most appropriate attribute value to provide to the requesting user in response the request.

In some implementations, for each of the candidate values, the system provides the features for the candidate value as input to a machine learning model. The machine learning model is a machine learning model that is configured to receive a set of features for a candidate value and to determine a likelihood score for the candidate value from the features.

For example, the machine learning model can be a generalized linear model that applies a respective weight to each of the features to generate the likelihood score for the candidate value.

As another example, the machine learning model can be a neural network, e.g., a feedforward neural network or a recurrent neural network, that has been configured through training to receive the features and to process the features to generate the likelihood score.

In some other implementations, the system assigns a respective weight to each claim based on the features and combines the weights to determine the likelihood score for the candidate value. For example, the system can sum the weights for each claim to determine an initial likelihood score for the candidate value. The system can then normalize the initial likelihood scores to determine a final likelihood score for each candidate value.

For example, to determine the weight for a given claim, the system can adjust the confidence feature for the claim based on the entity-claimant relationship features and the requesting user-claimant relationship features for the claim. In particular, the system can increase the confidence feature for claims that have entity-claimant relationship features that indicate that the claimant has a strong relationship with the entity, decrease the confidence feature for claims that have entity-claimant relationship features that indicate that the claimant has a weak relationship with the entity, or both. The system can also increase the confidence feature for claims that have requesting user-claimant relationship features that indicate that the claimant has a strong relationship with the requesting user, decrease the confidence feature for claims that have entity-claimant relationship features that indicate that the claimant has a weak relationship with the requesting user, or both.

The system selects the candidate attribute value having the highest likelihood score as the user-specific value for the particular attribute (step 408).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In this specification, the term “database” will be used broadly to refer to any collection of data: the data does not need to be structured in any particular way, or structured at all, and it can be stored on storage devices in one or more locations.

Similarly, in this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising one or more computers and one or more storage devices storing instructions that when executed by the one or more computers cause the one or more computers to perform operations comprising:
maintaining data representing an information graph that includes claims about entities,
wherein the maintained data comprises data representing a plurality of clusters, each cluster corresponding to a different entity and comprising a plurality of claims about the corresponding entity, and
wherein the maintained data comprises, for each claim in each cluster, a respective data structure that identifies at least (i) the corresponding entity for the cluster, (ii) an attribute value of the corresponding entity about which the claim is an assertion, and (iii) a respective claimant user that made the assertion in the claim,
receiving a request for a value of a particular attribute of a particular entity that has been submitted by a requesting user;
determining, from the maintained data, that the claims in a particular cluster corresponding to the particular entity assert at least two different values for the particular attribute;
determining, from attribute values for the particular attribute identified by the claims in the particular cluster and based on the claimant users that made the assertions in the claims in the particular cluster, a user-specific attribute value for the particular attribute value; and
providing the user-specific attribute value in response to the request.

2. The system of claim 1, the operations further comprising:
in response to the request, identifying the particular cluster as a responsive cluster for the request.

3. The system of claim 2, wherein identifying the particular cluster as a responsive cluster comprises:
determining a respective ranking score for each of the plurality of clusters; and
determining that the particular cluster is a highest-scoring cluster according to the respective ranking scores.

4. The system of claim 3, wherein determining a respective ranking score for each of the plurality of clusters comprises:
determining a respective characteristic score for each of one or more characteristics of the cluster; and
combining the respective characteristic scores to generate the ranking score for the cluster.

5. The system of claim 4, wherein the one or more characteristics include one or more requester-independent characteristics and one or more requester-dependent characteristics.

6. The system of claim 1, wherein determining, from attribute values for the particular attribute identified by the claims in the particular cluster, a user-specific attribute value for the particular attribute value comprises:
determining a set of candidate attribute values from the attribute values for the particular attribute identified by the claims in the particular cluster;
for each candidate attribute value:
determining a plurality of features of the claims in the particular cluster that make an assertion about the candidate attribute value and
determining a likelihood score for the candidate attribute value from the features, wherein the likelihood score represents a likelihood that the candidate attribute value feature is a most appropriate attribute value to provide to the requesting user in response the request; and
selecting a candidate attribute value having a highest likelihood score as the user-specific attribute value.

7. The system of claim 6, wherein the plurality of features includes a requester relationship feature for a particular claim that measures how related a claimant of the particular claim is to the requesting user.

8. The system of claim 6, wherein the plurality of features includes an entity relationship feature for a particular claim that measures how related a claimant of the particular claim is to the particular entity.

9. The system of claim 6, wherein the plurality of features includes a confidence feature for a particular claim that measures how confident a claimant of the particular claim is that the candidate attribute value is a true value for the particular attribute.

10. The system of claim 6, wherein determining the likelihood score for the candidate attribute value from the features of the candidate attribute value comprises:
providing the features as input to a machine learning model that is configured to process the features to generate the confidence score.

11. The system of claim 6, wherein determining the likelihood score for the candidate attribute value from the features of the candidate attribute value comprises:
determining, from the features, a weight for each of the claims that make an assertion about the particular attribute value; and
determining the likelihood score from the weights for the claims.

12. A method comprising:
maintaining data representing an information graph that includes claims about entities,
wherein the maintained data comprises data representing a plurality of clusters, each cluster corresponding to a different entity and comprising a plurality of claims about the corresponding entity, and
wherein the maintained data comprises, for each claim in each cluster, a respective data structure that identifies at least (i) the corresponding entity for the cluster, (ii) an attribute value of the corresponding entity about which the claim is an assertion, and (iii) a respective claimant user that made the assertion in the claim,
receiving a request for a value of a particular attribute of a particular entity that has been submitted by a requesting user;
determining, from the maintained data, that the claims in a particular cluster corresponding to the particular entity assert at least two different values for the particular attribute;
determining, from attribute values for the particular attribute identified by the claims in the particular cluster, a user-specific attribute value for the particular attribute value; and
providing the user-specific attribute value in response to the request.

13. The method of claim 12, wherein determining, from attribute values for the particular attribute identified by the claims in the particular cluster, a user-specific attribute value for the particular attribute value comprises:
determining a set of candidate attribute values from the attribute values for the particular attribute identified by the claims in the particular cluster;
for each candidate attribute value:
determining a plurality of features of the claims in the particular cluster that make an assertion about the candidate attribute value and
determining a likelihood score for the candidate attribute value from the features, wherein the likelihood score represents a likelihood that the candidate attribute value feature is a most appropriate attribute value to provide to the requesting user in response the request; and
selecting a candidate attribute value having a highest likelihood score as the user-specific attribute value.

14. The method of claim 13, wherein the plurality of features includes a requester relationship feature for a particular claim that measures how related a claimant of the particular claim is to the requesting user.

15. The method of claim 13, wherein the plurality of features includes an entity relationship feature for a particular claim that measures how related a claimant of the particular claim is to the particular entity.

16. The method of claim 13, wherein the plurality of features includes a confidence feature for a particular claim that measures how confident a claimant of the particular claim is that the candidate attribute value is a true value for the particular attribute.

17. The method of claim 13, wherein determining the likelihood score for the candidate attribute value from the features of the candidate attribute value comprises:
providing the features as input to a machine learning model that is configured to process the features to generate the confidence score.

18. The method of claim 13, wherein determining the likelihood score for the candidate attribute value from the features of the candidate attribute value comprises:
determining, from the features, a weight for each of the claims that make an assertion about the particular attribute value; and
determining the likelihood score from the weights for the claims.

19. One or more computer readable media storing instructions that when executed by one or more computers cause the one or more computers to perform operations comprising:
maintaining data representing an information graph that includes claims about entities,
wherein the maintained data comprises data representing a plurality of clusters, each cluster corresponding to a different entity and comprising a plurality of claims about the corresponding entity, and
wherein the maintained data comprises, for each claim in each cluster, a respective data structure that identifies at least (i) the corresponding entity for the cluster, (ii) an attribute value of the corresponding entity about which the claim is an assertion, and (iii) a respective claimant user that made the assertion in the claim,
receiving a request for a value of a particular attribute of a particular entity that has been submitted by a requesting user;
determining, from the maintained data, that the claims in a particular cluster corresponding to the particular entity assert at least two different values for the particular attribute;
determining, from attribute values for the particular attribute identified by the claims in the particular cluster, a user-specific attribute value for the particular attribute value; and
providing the user-specific attribute value in response to the request.

20. The computer readable media of claim 19, wherein determining, from attribute values for the particular attribute identified by the claims in the particular cluster, a user-specific attribute value for the particular attribute value comprises:
determining a set of candidate attribute values from the attribute values for the particular attribute identified by the claims in the particular cluster;
for each candidate attribute value:
determining a plurality of features of the claims in the particular cluster that make an assertion about the candidate attribute value and
determining a likelihood score for the candidate attribute value from the features, wherein the likelihood score represents a likelihood that the candidate attribute value feature is a most appropriate attribute value to provide to the requesting user in response the request; and
selecting a candidate attribute value having a highest likelihood score as the user-specific attribute value.
